(19) United States
(12) Patent Application Publication
(10) Pub. No.: US 2023/0247559 A1
(43) Pub. Date: Aug. 3, 2023

(54) POWER SAVINGS IN A MULTI-CONNECTIVITY USER EQUIPMENT

(71) Applicant: QUALCOMM Incorporated, San Diego, CA (US)

(72) Inventors: Mahbod GHELICHI, San Diego, CA (US); James Francis GEEKIE, Carlsbad, CA (US); Jittra JOOTAR, San Diego, CA (US); Arvind Vardarajan SANTHANAM, San Diego, CA (US); Kuo-Chun LEE, San Diego, CA (US); Vanitha Aravamudhan KUMAR, San Diego, CA (US)

(21) Appl. No.: 18/298,154

(22) Filed: Apr. 10, 2023

Related U.S. Application Data
(62) Division of application No. 16/401,003, filed on May 1, 2019, now abandoned.

(51) Int. Cl. H04W 52/02; H04L 43/0888; H04L 43/16; H04W 24/02; H04W 24/10

(52) U.S. Cl. CPC H04W 52/0277; H04L 43/0888; H04L 43/16; H04W 24/02; H04W 24/10; H04W 52/0251; H04W 52/0254; H04W 52/0258; H04W 88/06

(57) ABSTRACT

Methods, systems, and devices for wireless communication in a multi-connectivity user equipment (UE) are described. The UE may communicate with one or more base stations via a first radio access technology (RAT). The UE may determine whether the UE is in a selected state. The selected state may correspond to one or more modes of operation (e.g., a doze mode, a relaxed doze mode, an active WiFi communication mode, a low battery mode). The UE may disable communication via a second RAT in response to determining that the UE is in the selected state. The UE may continue to communicate via the first RAT.

### CROSS REFERENCE

The present Application for Patent is a Divisional of U.S. patent application Ser. No. 16/401,003 by Mahbod GHELICHI et al., entitled “POWER SAVINGS IN A MULTI-CONNECTIVITY USER EQUIPMENT,” filed May 1, 2019, assigned to the assignee hereof, and expressly incorporated by reference herein.

### BACKGROUND

### Field of the Disclosure

The following relates generally to wireless communication, and more specifically to power savings in a multi-connectivity (e.g., dual-connectivity) user equipment.

### Description of Related Art

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as a Long Term Evolution (LTE) systems or LTE-Advanced (LTE-A) systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform-spread-OFDM (DFT-S-OFDM). A wireless multiple-access communications system may include a number of base stations or network access nodes, each simultaneously supporting communication for multiple communication devices, which may be otherwise known as user equipment (UE).

A UE may be configured to simultaneously connect to and communicate with one or more networks using multiple cells, such as in a multi-connectivity (e.g., dual connectivity) scenario. For example, a UE may be configured to communicate via a 4G LTE radio access technology (RAT) and a 5G RAT simultaneously. This configuration may be referred to as a non-standalone mode of operation for 5G. A 5G network may enable an increased throughput (e.g., gigabit throughput) compared to previous generations of wireless wide area networks (WWANs).

### SUMMARY

The described techniques relate to improved methods, systems, devices, or apparatuses that support power savings in a multi-connectivity user equipment (UE).

A method of wireless communication in a multi-connectivity UE is described. The method may include communicating with one or more base stations via a first radio access technology (RAT). The method may include determining whether the UE is in a selected state, disabling communication via a second RAT in response to determining that the UE is in the selected state, and continuing to communicate via the first RAT. In one aspect, the second RAT may have a higher throughput capability than the first RAT. In another aspect, the second RAT may have a higher power consumption at the UE than the first RAT when the second RAT is enabled.

A multi-connectivity UE for wireless communication is described. The UE may include a processor, memory coupled to the processor, and instructions stored in the memory. The instructions may be executable by the processor to cause the UE to communicate with one or more base stations via a first radio access technology (RAT). The instructions may be executable by the processor to cause the UE to determine whether the UE is in a selected state, disable communication via a second RAT in response to determining that the UE is in the selected state, and continue to communicate via the first RAT. In one aspect, the second RAT may have a higher throughput capability than the first RAT. In another aspect, the second RAT may have a higher power consumption at the UE than the first RAT when the second RAT is enabled.

Another multi-connectivity UE for wireless communication is described. The UE may include means for communicating with one or more base stations via a first radio access technology (RAT). The UE may include means for determining whether the UE is in a selected state, means for disabling communication via a second RAT in response to determining that the UE is in the selected state, and means for continuing to communicate via the first RAT. In one aspect, the second RAT may have a higher throughput capability than the first RAT. In another aspect, the second RAT may have a higher power consumption at the UE than the first RAT when the second RAT is enabled.

A non-transitory computer readable medium storing code for wireless communication in a multi-connectivity UE is described. The code may include instructions executable by a processor to communicate with one or more base stations via a first radio access technology (RAT). The code may include instructions executable by the processor to cause the UE to determine whether the UE is in a selected state, disable communication via a second RAT in response to determining that the UE is in the selected state, and continue to communicate via the first RAT. In one aspect, the second RAT may have a higher throughput capability than the first RAT. In another aspect, the second RAT may have a higher power consumption at the UE than the first RAT when the second RAT is enabled.

### BRIEF DESCRIPTION OF THE DRAWINGS

FIG. 1 illustrates an example of a system for wireless communication that supports power savings in a multi-connectivity (e.g., dual-connectivity) user equipment (UE) in accordance with aspects of the present disclosure.

FIG. 2 illustrates an example of a wireless communications system that supports multi-connectivity in accordance with aspects of the present disclosure.

FIGS. 3 and 4 are example timeline diagrams of power usage of multi-connectivity UEs in various modes of operation.

FIG. 5 shows a block diagram of a device that supports power savings in a multi-connectivity UE in accordance with aspects of the present disclosure.

FIG. 6 illustrates a block diagram of a system including a multi-connectivity UE in accordance with aspects of the present disclosure.

FIGS. 7 and 8 illustrate methods for power savings in a multi-connectivity UE in accordance with aspects of the present disclosure.

### DETAILED DESCRIPTION

In some wireless communications systems, a user equipment (UE) may communicate with one or more networks using multi-connectivity (e.g., dual connectivity (DC)). In the following description, DC is referred to as an example of multi-connectivity. However, it is contemplated that the following description may utilize more than two wireless connections (e.g., wireless wide area network (WWAN) connections and/or wireless local area network (WLAN) connections). In a DC scenario, the UE may simultaneously communicate with different base stations, where a first base station may provide a first cell and be referred to as a master node. Likewise, a second base station providing a second cell of the DC deployment may be referred to as a secondary node, and the first and second cells may each be associated with a same or different radio access technology (RAT). As such, various DC deployments may be referred to as evolved universal terrestrial radio access (E-UTRA) new radio (NR)-dual connectivity (EN-DC), NR E-UTRA-DC (NE-DC), NR NR-DC, LTE LTE-DC, or may include other types of multi-radio access technology-dual connectivity (MR-DC) deployments based on the RAT implemented by each cell. In any case, the different cells a UE communicates on for DC may use the same or different radio frequency (RF) spectrum bands.

In one example DC scenario, 5G NR may be deployed together with 4G LTE. 4G LTE may provide the master node while 5G NR provides the secondary node. 5G NR may be characterized as having a larger operating bandwidth compared to 4G LTE (or other previous generations (e.g., 3G)), which enables 5G to provide a higher throughput capability (e.g., gigabit throughput). The larger operating bandwidth and higher throughput of 5G NR may lead modem and related radio frequency (RF) designs that consumes more power compared to previous generation designs (e.g., 4G LTE designs). The larger operating bandwidth and/or higher throughput of 5G NR, however, may not be fully utilized in some scenarios. For example, the throughput required for some scenarios may be adequately addressed by 4G LTE. Described, herein, are several techniques that may provide power savings for multi-connectivity UEs. In one example, an approach is described to save battery power when the higher throughput of 5G NR is not required to meet a desired performance level. In such a scenario, 5G NR may be disabled to save battery power. In one aspect, the approach may correspond to a cross-layer design (e.g., medium access control (MAC) layer or higher layers communicating throughput information to a physical (PHY) layer) to determine when to disable 5G NR. When 5G NR is disabled, wireless communications may be carried out via another connection (e.g., 4G LTE, WiFi).

Aspects of the disclosure are initially described in the context of a wireless communications system. Aspects of the disclosure are further illustrated by and described with reference to timeline diagrams, apparatus diagrams, system diagrams, and flowcharts that relate to power savings in a multi-connectivity UE.

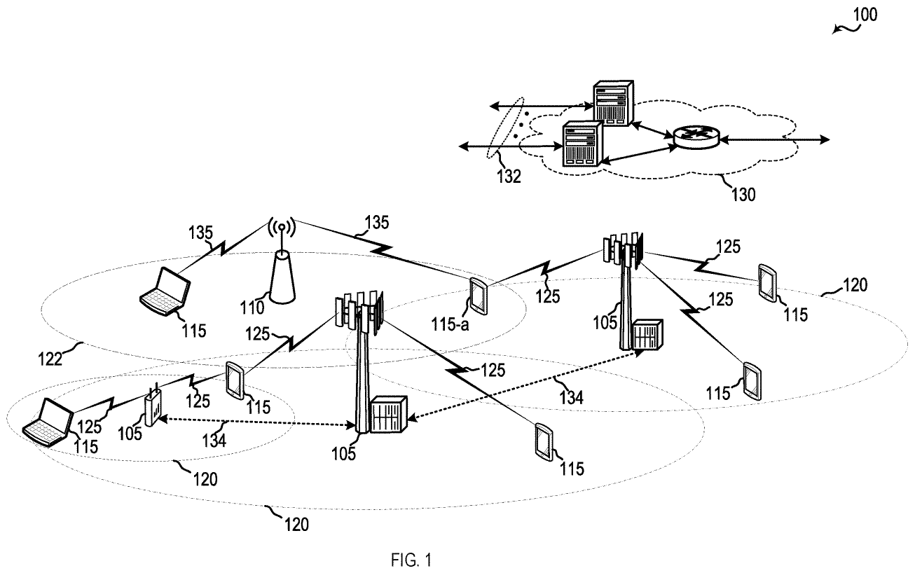

FIG. 1 illustrates an example of a wireless communications system 100 that supports power savings in a multi-connectivity UE in accordance with various aspects of the present disclosure. The wireless communications system 100 includes base stations 105, UEs 115, and a core network 130. In some examples, the wireless communications system 100 may be a Long Term Evolution (LTE) network, an LTE-Advanced (LTE-A) network, a New Radio (NR) network, or a combination thereof. Wireless communication system 100 may support power savings in a multi-connectivity UE by configuring the UE to disable the functionality associated with one of the radio access technologies (RATs) in one or more scenarios. In some cases, wireless communications system 100 may support enhanced broadband communications, ultra-reliable (e.g., mission critical) communications, low latency communications, or communications with low-cost and low-complexity devices.

Base stations 105 may wirelessly communicate with UEs 115 via one or more base station antennas. Base stations 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. Wireless communications system 100 may include base stations 105 of different types (e.g., macro or small cell base stations). The UEs 115 described herein may be able to communicate with various types of base stations 105 and network equipment including macro eNBs, small cell eNBs, gNBs, relay base stations, and the like.

Each base station 105 may be associated with a particular geographic coverage area 110 in which communications with various UEs 115 is supported. Each base station 105 may provide communication coverage for a respective geographic coverage area 110 via communication links 125, and communication links 125 between a base station 105 and a UE 115 may utilize one or more carriers. Communication links 125 shown in wireless communications system 100 may include uplink transmissions from a UE 115 to a base station 105, or downlink transmissions, from a base station 105 to a UE 115. Downlink transmissions may also be called forward link transmissions while uplink transmissions may also be called reverse link transmissions.

The geographic coverage area 110 for a base station 105 may be divided into sectors making up only a portion of the geographic coverage area 110, and each sector may be associated with a cell. For example, each base station 105 may provide communication coverage for a macro cell, a small cell, a hot spot, or other types of cells, or various combinations thereof. In some examples, a base station 105 may be movable and therefore provide communication coverage for a moving geographic coverage area 110. In some examples, different geographic coverage areas 110 associated with different technologies may overlap, and overlapping geographic coverage areas 110 associated with different technologies may be supported by the same base station 105 or by different base stations 105. For example, the same base station 105 or different base stations 105 may be configured to communicate using multiple RATs, such as 5G NR and 4G LTE, simultaneously, and the coverage areas 110 associated with the multiple RATs may overlap completely or partly. The wireless communications system 100 may include, for example, a heterogeneous LTE/LTE-A or NR network in which different types of base stations 105 provide coverage for various geographic coverage areas 110.

The term “cell” refers to a logical communication entity used for communication with a base station 105 (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices. In some cases, the term “cell” may refer to a portion of a geographic coverage area 110 (e.g., a sector) over which the logical entity operates.

UEs 115 may be dispersed throughout the wireless communications system 100, and each UE 115 may be stationary or mobile. A UE 115 may also be referred to as a mobile device, a wireless device, a remote device, a handheld device, or a subscriber device, or some other suitable terminology, where the “device” may also be referred to as a unit, a station, a terminal, or a client. A UE 115 may also be a personal electronic device such as a cellular phone, a personal digital assistant (PDA), a tablet computer, a laptop computer, or a personal computer. In some examples, a UE 115 may also refer to a wireless local loop (WLL) station, an Internet of Things (IoT) device, an Internet of Everything (IoE) device, or an MTC device, or the like, which may be implemented in various articles such as appliances, vehicles, meters, or the like.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples half-duplex communications may be performed at a reduced peak rate. Other power conservation techniques for UEs 115 include entering a power saving “deep sleep” mode when not engaging in active communications, or operating over a limited bandwidth (e.g., according to narrowband communications). In some cases, UEs 115 may be designed to support critical functions (e.g., mission critical functions), and a wireless communications system 100 may be configured to provide ultra-reliable communications for these functions.

In some cases, a UE 115 may also be able to communicate directly with other UEs 115 (e.g., using a peer-to-peer (P2P) or device-to-device (D2D) protocol). One or more of a group of UEs 115 utilizing D2D communications may be within the geographic coverage area 110 of a base station 105. Other UEs 115 in such a group may be outside the geographic coverage area 110 of a base station 105, or be otherwise unable to receive transmissions from a base station 105. In some cases, groups of UEs 115 communicating via D2D communications may utilize a one-to-many (1:M) system in which each UE 115 transmits to every other UE 115 in the group. In some cases, a base station 105 facilitates the scheduling of resources for D2D communications. In other cases, D2D communications are carried out between UEs 115 without the involvement of a base station 105.

Base stations 105 may communicate with the core network 130 and with one another. For example, base stations 105 may interface with the core network 130 through backhaul links 132 (e.g., via an S1 or other interface). Base stations 105 may communicate with one another over backhaul links 134 (e.g., via an X2 or other interface) either directly (e.g., directly between base stations 105) or indirectly (e.g., via core network 130).

The core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one Packet Data Network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP Multimedia Subsystem (IMS), or a Packet-Switched (PS) Streaming Service.

At least some of the network devices, such as a base station 105, may include subcomponents such as an access network entity, which may be an example of an access node controller (ANC). Each access network entity may communicate with UEs 115 through a number of other access network transmission entities, which may be referred to as a radio head, a smart radio head, or a transmission/reception point (TRP). In some configurations, various functions of each access network entity or base station 105 may be distributed across various network devices (e.g., radio heads and access network controllers) or consolidated into a single network device (e.g., a base station 105).

Wireless communications system 100 may operate using one or more frequency bands, typically in the range of 300 MHz to 300 GHz. Generally, the region from 300 MHz to 3 GHz is known as the ultra-high frequency (UHF) region or decimeter band, since the wavelengths range from approximately one decimeter to one meter in length. UHF waves may be blocked or redirected by buildings and environmental features. However, the waves may penetrate structures sufficiently for a macro cell to provide service to UEs 115 located indoors. Transmission of UHF waves may be associated with smaller antennas and shorter range (e.g., less than 100 km) compared to transmission using the smaller frequencies and longer waves of the high frequency (HF) or very high frequency (VHF) portion of the spectrum below 300 MHz.

Wireless communications system 100 may also operate in a super high frequency (SHF) region using frequency bands from 3 GHz to 30 GHz, also known as the centimeter band. The SHF region includes bands such as the 5 GHz industrial, scientific, and medical (ISM) bands, which may be used opportunistically by devices that can tolerate interference from other users.

Wireless communications system 100 may also operate in an extremely high frequency (EHF) region of the spectrum (e.g., from 30 GHz to 300 GHz), also known as the millimeter band. In some examples, wireless communications system 100 may support millimeter wave (mmW) communications between UEs 115 and base stations 105, and EHF antennas of the respective devices may be even smaller and more closely spaced than UHF antennas. In some cases, this may facilitate use of antenna arrays within a UE 115 (e.g., for multiple-input multiple-output (MIMO) operations such as spatial multiplexing, or for directional beamforming). However, the propagation of EHF transmissions may be subject to even greater atmospheric attenuation and shorter range than SHF or UHF transmissions. Techniques disclosed herein may be employed across transmissions that use one or more different frequency regions, and designated use of bands across these frequency regions may differ by country or regulating body.

In some cases, wireless communications system 100 may utilize both licensed and unlicensed radio frequency spectrum bands. For example, wireless communications system 100 may employ LTE License Assisted Access (LTE-LAA) or LTE-Unlicensed (LTE-U) radio access technology or NR technology in an unlicensed band such as the 5 GHz ISM band. When operating in unlicensed radio frequency spectrum bands, wireless devices such as base stations 105 and UEs 115 may employ listen-before-talk (LBT) procedures to ensure a frequency channel is clear before transmitting data. In some cases, operations in unlicensed bands may be based on a CA configuration in conjunction with CCs operating in a licensed band. Operations in unlicensed spectrum may include downlink transmissions, uplink transmissions, peer-to-peer transmissions, or a combination of these. Duplexing in unlicensed spectrum may be based on frequency division duplexing (FDD), time division duplexing (TDD), or a combination of both.

In some cases, the antennas of a base station 105 or UE 115 may be located within one or more antennas or antenna arrays, which may support MIMO operations such as spatial multiplexing, or transmit or receive beamforming. For example, one or more base station antennas or antenna arrays may be co-located at an antenna assembly, such as an antenna tower. In some cases, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations.

MIMO wireless systems use a transmission scheme between a transmitting device (e.g., a base station 105) and a receiving device (e.g., a UE 115), where both transmitting device and the receiving device are equipped with multiple antennas. MIMO communications may employ multipath signal propagation to increase the utilization of a radio frequency spectrum band by transmitting or receiving different signals via different spatial paths, which may be referred to as spatial multiplexing. The different signals may, for example, be transmitted by the transmitting device via different antennas or different combinations of antennas. Likewise, the different signals may be received by the receiving device via different antennas or different combinations of antennas. Each of the different signals may be referred to as a separate spatial stream, and the different antennas or different combinations of antennas at a given device (e.g., the orthogonal resource of the device associated with the spatial dimension) may be referred to as spatial layers.

Beamforming, which may also be referred to as spatial filtering, directional transmission, or directional reception, is a signal processing technique that may be used at a transmitting device or a receiving device (e.g., a base station 105 or a UE 115) to shape or steer an antenna beam (e.g., a transmit beam or receive beam) along a direction between the transmitting device and the receiving device. Beamforming may be achieved by combining the signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain phase offset, timing advance/delay, or amplitude adjustment to signals carried via each of the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In one example, a base station 105 may multiple use antennas or antenna arrays to conduct beamforming operations for directional communications with a UE 115. For instance, signals may be transmitted multiple times in different directions, which may include a signal being transmitted according to different beamforming weight sets associated with different directions of transmission. A receiving device (e.g., a UE 115, which may be an example of a mmW receiving device) may try multiple receive beams when receiving various signals from the base station 105, such as synchronization signals or other control signals. For example, a receiving device may try multiple receive directions by receiving via different antenna subarrays, by processing received signals according to different antenna subarrays, by receiving according to different receive beamforming weight sets applied to signals received at a plurality of antenna elements of an antenna array, or by processing received signals according to different receive beamforming weight sets applied to signals received at a plurality of antenna elements of an antenna array, any of which may be referred to as “listening” according to different receive beams or receive directions.

In some cases, wireless communications system 100 may be a packet-based network that operate according to a layered protocol stack. In the user plane, communications at the bearer or Packet Data Convergence Protocol (PDCP) layer may be IP-based. A Radio Link Control (RLC) layer may in some cases perform packet segmentation and reassembly to communicate over logical channels. A Medium Access Control (MAC) layer may perform priority handling and multiplexing of logical channels into transport channels. The MAC layer may also use hybrid automatic repeat request (HARQ) to provide retransmission at the MAC layer to improve link efficiency. In the control plane, the Radio Resource Control (RRC) protocol layer may provide establishment, configuration, and maintenance of an RRC connection between a UE 115 and a base station 105 or core network 130 supporting radio bearers for user plane data. At the Physical (PHY) layer, transport channels may be mapped to physical channels.

In some cases, UEs 115 and base stations 105 may support retransmissions of data to increase the likelihood that data is received successfully. HARQ feedback is one technique of increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., signal-to-noise conditions). In some cases, a wireless device may support same-slot HARQ feedback, where the device may provide HARQ feedback in a specific slot for data received in a previous symbol in the slot. In other cases, the device may provide HARQ feedback in a subsequent slot, or according to some other time interval.

Time intervals in LTE or NR may be expressed in multiples of a basic time unit, which may, for example, refer to a sampling period of Ts=1/30,720,000 seconds. Time intervals of a communications resource may be organized according to radio frames each having a duration of 10 milliseconds (Tf=307200*Ts). The radio frames may be identified by a system frame number (SFN) ranging from 0 to 1023. Each frame may include ten subframes numbered from 0 to 9, and each subframe may have a duration of 1 millisecond. A subframe may be further divided into two slots each having a duration of 0.5 milliseconds, and each slot may contain 6 or 7 modulation symbol periods (e.g., depending on the length of the cyclic prefix prepended to each symbol period). Excluding the cyclic prefix, each symbol period may contain 2048 sampling periods. In some cases, a subframe may be the smallest scheduling unit of the wireless communications system 100, and may be referred to as a transmission time interval (TTI). In other cases, a smallest scheduling unit of the wireless communications system 100 may be shorter than a subframe or may be dynamically selected (e.g., in bursts of shortened TTIs (sTTIs) or in selected component carriers using sTTIs).

In some wireless communications systems, a slot may further be divided into multiple mini-slots containing one or more symbols and in some instances, a symbol of a mini-slot or a mini-slot may be the smallest unit of scheduling. Each symbol may vary in duration depending on the subcarrier spacing or frequency band of operation, for example. Some wireless communications systems may implement slot aggregation in which multiple slots or mini-slots may be aggregated together for communication between a UE 115 and a base station 105.

A resource element may consist of one symbol period (e.g., a duration of one modulation symbol) and one subcarrier (e.g., a 15 kHz frequency range). A resource block may contain 12 consecutive subcarriers in the frequency domain (e.g., collectively forming a “carrier”) and, for a normal cyclic prefix in each orthogonal frequency-division multiplexing (OFDM) symbol, 7 consecutive OFDM symbol periods in the time domain (1 slot), or 84 total resource elements across the frequency and time domains. The number of bits carried by each resource element may depend on the modulation scheme (the configuration of modulation symbols that may be applied during each symbol period). Thus, the more resource elements that a UE 115 receives and the higher the modulation scheme (e.g., the higher the number of bits that may be represented by a modulation symbol according to a given modulation scheme), the higher the data rate may be for the UE 115. In MIMO systems, a wireless communications resource may refer to a combination of a radio frequency spectrum band resource, a time resource, and a spatial resource (e.g., spatial layers), and the use of multiple spatial layers may further increase the data rate for communications with a UE 115.

The term “carrier” refers to a set of radio frequency spectrum resources having a defined organizational structure for supporting uplink or downlink communications over a communication link 125. For example, a carrier of a communication link 125 may include a portion of a radio frequency spectrum band that may also be referred to as a frequency channel. In some examples a carrier may be made up of multiple sub-carriers (e.g., waveform signals of multiple different frequencies). A carrier may be organized to include multiple physical channels, where each physical channel may carry user data, control information, or other signaling.

The organizational structure of the carriers may be different for different radio access technologies (e.g., LTE, LTE-A, NR, etc.). For example, communications over a carrier may be organized according to TTIs or slots, each of which may include user data as well as control information or signaling to support decoding the user data. A carrier may also include dedicated acquisition signaling (e.g., synchronization signals or system information, etc.) and control signaling that coordinates operation for the carrier. In some examples (e.g., in a carrier aggregation configuration), a carrier may also have acquisition signaling or control signaling that coordinates operations for other carriers.

Physical channels may be multiplexed on a carrier according to various techniques. A physical control channel and a physical data channel may be multiplexed on a downlink carrier, for example, using time division multiplexing (TDM) techniques, frequency division multiplexing (FDM) techniques, or hybrid TDM-FDM techniques. In some examples, control information transmitted in a physical control channel may be distributed between different control regions in a cascaded manner (e.g., between a common control region or common search space and one or more UE-specific control regions or UE-specific search spaces).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of predetermined bandwidths for carriers of a particular radio access technology (e.g., 1.4, 3, 5, 10, 15, or 20 MHz). In some examples the system bandwidth may refer to a minimum bandwidth unit for scheduling communications between a base station 105 and a UE 115. In other examples a base station 105 or a UE 115 may also support communications over carriers having a smaller bandwidth than the system bandwidth. In such examples, the system bandwidth may be referred to as “wideband” bandwidth and the smaller bandwidth may be referred to as a “narrowband” bandwidth. In some examples of the wireless communications system 100, wideband communications may be performed according to a 20 MHz carrier bandwidth and narrowband communications may be performed according to a 1.4 MHz carrier bandwidth.

Devices of the wireless communications system 100 (e.g., base stations or UEs 115) may have a hardware configuration that supports communications over a particular carrier bandwidth, or may be configurable to support communications over one of a set of carrier bandwidths. For example, base stations 105 or UEs 115 may perform some communications according to a system bandwidth (e.g., wideband communications), and may perform some communications according to a smaller bandwidth (e.g., narrowband communications). In some examples, the wireless communications system 100 may include base stations 105 and/or UEs that can support simultaneous communications via carriers associated with more than one different bandwidth.

Wireless communications system 100 may support communication with a UE 115 on multiple cells or carriers, a feature which may be referred to as carrier aggregation (CA) or multi-carrier operation. A UE 115 may be configured with multiple downlink CCs and one or more uplink CCs according to a carrier aggregation configuration. Carrier aggregation may be used with both FDD and TDD component carriers.

In some cases, wireless communications system 100 may utilize enhanced component carriers (eCCs). An eCC may be characterized by one or more features including wider carrier or frequency channel bandwidth, shorter symbol duration, shorter TTI duration, or modified control channel configuration. In some cases, an eCC may be associated with a carrier aggregation configuration or a dual connectivity configuration (e.g., when multiple serving cells have a suboptimal or non-ideal backhaul link). An eCC may also be configured for use in unlicensed spectrum or shared spectrum (e.g., where more than one operator is allowed to use the spectrum). An eCC characterized by wide carrier bandwidth may include one or more segments that may be utilized by UEs 115 that are not capable of monitoring the whole carrier bandwidth or are otherwise configured to use a limited carrier bandwidth (e.g., to conserve power).

In some cases, an eCC may utilize a different symbol duration than other CCs, which may include use of a reduced symbol duration as compared with symbol durations of the other CCs. A shorter symbol duration may be associated with increased spacing between adjacent subcarriers. A device, such as a UE 115 or base station 105, utilizing eCCs may transmit wideband signals (e.g., according to frequency channel or carrier bandwidths of 20, 40, 60, 80 MHz, etc.) at reduced symbol durations (e.g., 16.67 microseconds). A TTI in eCC may consist of one or multiple symbol periods. In some cases, the TTI duration (that is, the number of symbol periods in a TTI) may be variable.

Wireless communications systems such as an NR system may use a combination of licensed, shared, and unlicensed spectrum bands, among others. The flexibility of eCC symbol duration and subcarrier spacing may allow for the use of eCC across multiple spectrums. In some examples, NR shared spectrum may increase spectrum utilization and spectral efficiency, specifically through dynamic vertical (e.g., across frequency) and horizontal (e.g., across time) sharing of resources.

UEs 115 may be configured as multi-connectivity UEs in which UEs 115 are configured to communicate with one or more base stations 105 using multiple RATs (e.g., 5G NR, 4G LTE). UEs 115 may be configured to monitor the behavior and/or habits of a user in using different applications and in utilizing different throughputs associated with the RATs. UEs 115 may also be configured to adjust their power consumption based on the monitored behavior and/or habits. UEs 115 may adjust their power consumption by disabling one or more of its RATs. UEs 115 may determine to adjust their power consumption based on various factors as described in more detail below.

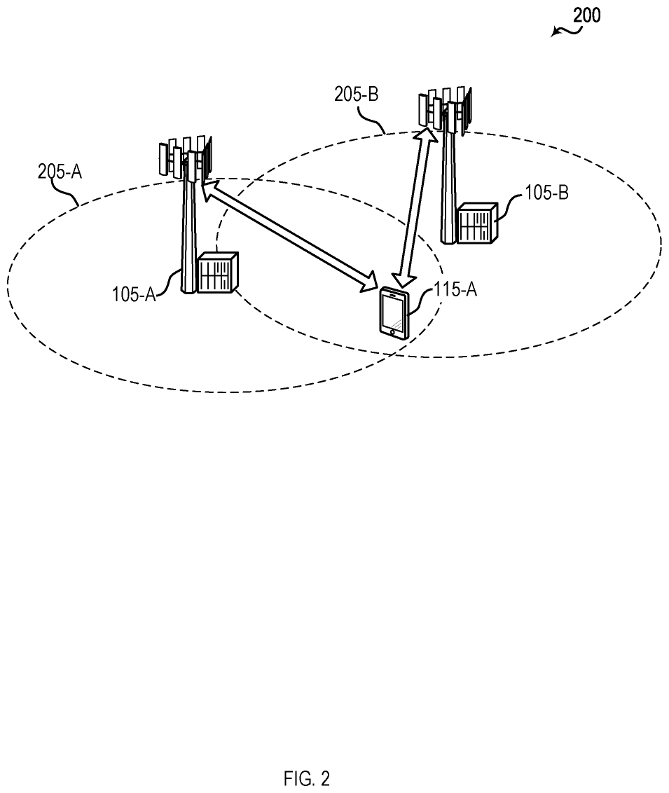

FIG. 2 illustrates an example of a wireless communication system 200 that supports power savings in a multi-connectivity UE in accordance with various aspects of the present disclosure. In some examples, wireless communications system 200 may implement aspects of wireless communications system 100. For example, wireless communications system 200 includes a first base station 105-a, a second base station 105-b, and a UE 115-a, which may be examples of the corresponding devices described with reference to FIG. 1. Wireless communications system 200 may support the use of techniques that enhance power savings in a multi-connectivity UE based on one or more various factors.

In wireless communications system 200, a UE 115-a may communicate with a network using a DC configuration. In such cases, UE 115-a may simultaneously communicate with different base stations 105 (e.g., first base station 105-a and second base station 105-b). First base station 105-a may provide a first cell 205-a and first base station 105-a may be referred to as a master node. First cell 205-a may correspond to a PCell in the DC deployment. Additionally, second base station 105-b may provide a second cell 205-b of the DC configuration, and second base station 105-b may be referred to as a secondary node. In some cases, second cell 205-b may correspond to a PSCell in the DC deployment, which may be configured with time-frequency resources for PUCCH. Additional SCells may associated with each base station 105-a and 105-b, where a set of cells (e.g., SCells) associated with the master node may correspond to a master cell group (MCG) and another set of SCells associated with the secondary node may correspond to a secondary cell group (SCG).

In some cases, the different base stations 105 and corresponding cells of the DC deployment may be associated with a same or different RAT. For instance, first base station 105-a and second base station 105-b may communicate using a first RAT and a second RAT, respectively. The first RAT and/or the second RAT may be the same or different and may include, for example, LTE, NR, or another RAT. As such, various DC deployments may sometimes be referred to as EN-DC, NE-DC, NR NR-DC, LTE LTE-DC, enhanced LTE (eLTE) eLTE-DC, or may include other types of MR-DC deployments based on the RAT that is used by each base station 105. In any case, the different cells of a DC deployment may use the same or different RF spectrum bands for communication with UE 115-a.

In some cases, DC deployments may use different radio bearers for transmitted messages for each cell. For instance, when first base station 105-a is configured as a master node that provides a set of serving cells corresponding to the MCG, first base station 105-a may use a first set of signaling radio bearers (SRBs) (e.g., SRB1, SRB2) to transport messages for the MCG, such as RRC messages. Additionally, when second base station 105-b is configured as a secondary node, second base station 105-b may provide another set of serving cells that correspond to the SCG and may use a second set of SRBs (e.g., SRB3) to transport messages for the SCG. In some examples, a split bearer configuration may be supported, where a particular protocol layer (e.g., a packet data convergence protocol (PDCP) layer) for both the master node and secondary node may be used to route data streams to/from UE 115-a. Here, an SRB (e.g., SRB1/SRB2) may be split between the master node and the secondary node, and downlink messages sent from the master node to UE 115-a may be routed via lower-layers (e.g., radio link control (RLC), medium access control (MAC), physical (PHY), etc.) of either first base station 105-a (e.g., the master node) or second base station 105-b (e.g., the secondary node). In other cases, downlink messages may be routed via the lower-layers of both the master and secondary nodes. In the uplink, RRC messages from UE 115-a may be transmitted to the master node via the secondary node using the split bearer (e.g., via a “leg” associated with the secondary node). For the signaling of data in the user plane, respective data radio bearers (DRBs) may be used by the MCG and SCG.

Additionally, or alternatively, UE 115-a may communicate with a single base station 105 (e.g., first base station 105-a) using multiple carriers (e.g., CCs, which may also be referred to as layers, channels, etc.). In such cases, a CC may refer to each of the carriers used by UE 115-a in carrier aggregation (CA) operations. Further, a serving cell of first base station 105-a may correspond to each CC used in CA operation, where each serving cell may be different (e.g., based on the path loss experienced by different CCs on different RF spectrum bands). In some examples, one carrier may be designated as a primary carrier, or primary CC (PCC), for UE 115-a, which may be served by a PCell of first base station 105-a. Additional carriers may be designated as secondary carriers, or secondary CCs (SCCs), which may be served by SCells of first base station 105-a. CA operations may use the same or different RF bands for communications. The previous and following descriptions may be applicable to CA scenarios. For example, one or more carriers (e.g., a secondary carrier) may be utilized, enabled, re-enabled, disabled, etc. similar to one or more RATs described in the multi-connectivity (e.g., DC) scenarios described herein.

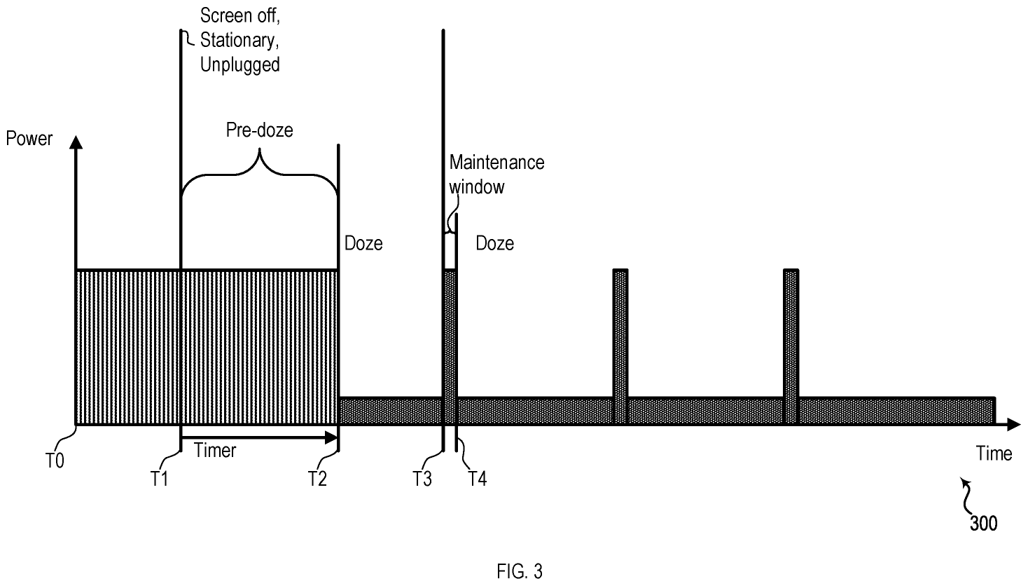

FIG. 3 shows a timeline diagram 300 corresponding to power consumption of a multi-connectivity UE over time, according to one example. UE 115 described in FIGS. 1 and 2 may be an example of the multi-connectivity UE associated with timeline diagram 300. From time T0 to T1, the multi-connectivity UE may be in a mode or state, which may be referred to as an active mode or state, in which the UE communicates with one or more base stations via multiple RATs (e.g., a 4G LTE RAT and a 5G NR RAT) such that various modules and components (e.g., modems, RF components) are powered up, active, and/or enabled. The multiple RATs may correspond to the same or different technology (e.g., all RATs may correspond to 5G NR, one RAT may correspond to 4G LTE and a second RAT may correspond to 5G NR). In one example, the UE may be in the active mode when a screen (e.g., touchscreen) of the UE is on, a throughput of the UE is above a threshold, the UE is plugged into a power source, or a combination thereof. In one example, the UE may be screen casting to another device in which the UE's screen is off but the UE is providing information for display on the other device. In this screen casting mode, the UE's screen may be considered “on” and the UE may be in the active mode. The active mode is represented by a relatively high power usage shown between T0 and T1. This mode or state of operation may be desired when the usage of the UE (e.g., application usage) warrants a relatively high throughput (e.g., communication rate (bits/second or packets/second)) provided by one or more of the multiple RATs. For example, applications (or other aspects) of the UE may call for a throughput that cannot be handled by 4G LTE alone in a manner satisfactory to a user of the UE. The relatively high throughput capability of 5G NR, however, may adequately handle the throughput requested by the UE.

At time T=T1, the UE enters a state, which may be referred to as a pre-doze mode or state, in which the UE's screen is off and the UE is stationary and unplugged. In one example, the UE continues to keep active the modules and components of the multiple RATs and, thus, the power consumed during the pre-doze mode is consistent with the power consumption of the active state (e.g., before T=T1). At T1, the UE may start a timer corresponding to a countdown of the pre-doze mode. If certain conditions of the pre-doze mode (e.g., screen off, stationary, unplugged) remain in effect for a selected (e.g., determined) period of time (e.g., one hour) the UE may transition to another mode or state, which may be referred to as a doze mode or state. If one or more of the conditions of the pre-doze mode changes before the timer expires, the UE may return to the active mode and reset the timer. In an example, the screen off condition may not be completely turned off (e.g., an always on state) but may display some information such as time and date.

As shown in FIG. 3, the UE remains in the pre-doze mode from T1 until the timer expires at T2, and the UE enters the doze mode at T2. In the doze mode, the UE may restrain applications from accessing network resources (e.g., such as WWAN resources and/or WiFi resources) for periods of time. The restraint of applications may reduce some of the power consumption of the UE as shown between T2 and T3. Conventionally, however, RATs or modems or RATs of the UE remain enabled during the doze mode. The doze mode may include maintenance windows, as shown between T3 and T4, in which synchronization messages can be communicated. Also, an application may request to reserve a slot in the maintenance window in which the application can attempt to access a server for data exchange. During the maintenance windows the power usage of the UE may be consistent with power usage during the active mode. The UE may remain in the doze mode as long as the conditions (e.g., screen off, stationary, unplugged) associated with the pre-doze mode remain in effect. If one or more of the conditions changes during the doze mode the UE exits the doze mode and returns to the active mode.

Various types of information such as types of modes (e.g., doze mode, pre-doze mode, active mode, low battery mode), operating system (OS) states, application statistics (active application statistics, background application statistics), battery voltage status, individual application throughputs may be accessed through a modem to application processor interface. Accordingly, this information may be leveraged to modify and further enhance power savings modes in multi-connectivity UEs. A cross-layer approach (e.g., a MAC layer or higher layers communicating information to a PHY layer) may enable one or more components (e.g., a modem) of one or more RATs to monitor and/or follow user behavior and habits in using applications or other aspects of the UE to adjust (e.g., reduce) the power consumption of the UE to thereby increase battery life and user satisfaction without sacrificing performance.

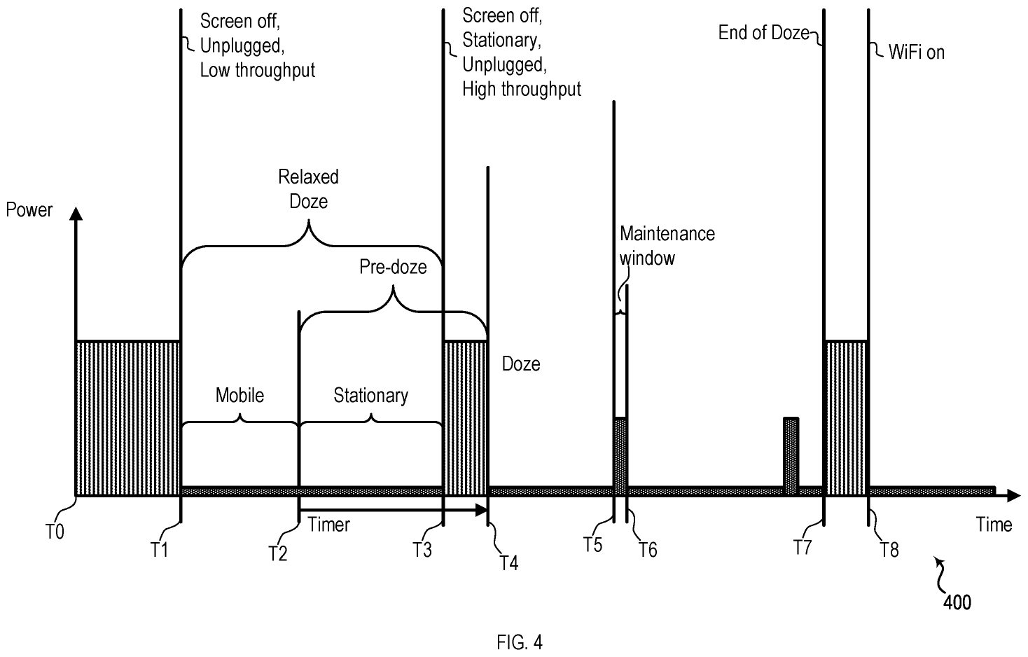

FIG. 4 shows a timeline diagram 400 corresponding to power consumption of a multi-connectivity UE over time, according to one example. UE 115 described in FIGS. 1 and 2 may be an example of the multi-connectivity UE associated with timeline diagram 400. From time T0 to T1, the multi-connectivity UE may be the active mode described above with reference to FIG. 3. The multiple RATs may correspond to the same or different technology (e.g., all RATs may correspond to 5G NR, one RAT may correspond to 4G LTE and a second RAT may correspond to 5G NR).

At time T1, the UE enters a mode or state, which may be referred to as a relaxed doze mode or state, in which the UE's screen is off, the UE is unplugged and a throughput of the UE is relatively low (e.g., below a threshold). Unlike the pre-doze mode and doze mode described with reference to FIG. 3, the relaxed doze mode is independent from (e.g., not conditional on) a mobility state of the UE (the UE may be mobile or stationary) as demonstrated by a mobile state between T1 and T2 and a stationary state between T2 and T3. Moreover, the relaxed doze mode is conditional on a throughput of the UE. The throughput of the UE may correspond to various measurements, estimations, statistics, and the like of the UE. For example, the throughput may correspond to one or more of: active application statistics, background application statistics, average application time usage information, OS states, UL and/or DL throughput estimations, MAC layer UL and/or DL throughput estimations, average throughput estimations (e.g., filtered throughput estimations, infinite impulse response (IIR) filtered throughput estimations) for one or more layers, and the like. In one example, the throughput estimation may correspond to a single RRC connection. In another example, the throughput estimation may correspond to multiple RRC connections (e.g., the throughput estimation may straddle multiple RRC connections) that may or may not have idle time. Idle time, if any, may be factored in when estimating the throughput.

In one example, the throughput may correspond to a throughput estimation (e.g., a MAC layer throughput estimation) that is based on a time window. For example, the UE may predict the throughput for the next 1000 ms. In another example, the throughput estimation may correspond to an IIR filtered throughput estimation determined based on the following equation:

A(n)=(1−α)*s(n)+α*A(n−1)

where s(n) represents the total throughput of DL and UL of multiple RATs (e.g., 4G LTE and 5G NR) over time T,

$$α = {2}^{- k} , k = \frac{T}{D}$$

and D is a configurable time constant. The throughput may be estimated or calculated on a periodic basis, such at every 2 seconds (i.e., T=2 seconds), or an aperiodic basis. The period to calculate or estimate the throughput is not limited to 2 seconds but may be any time period (e.g., 30 seconds as one other example).

The throughput may be compared to a threshold to determine whether to enter the relaxed doze mode. The threshold may be determined based on the throughput capacity of one of the RATs of the UE (e.g., the RAT with the lower throughput capacity). For example, when the UE is enabled to support 4G LTE and 5G NR simultaneously, the threshold may be related to the throughput capacity of 4G LTE. In this example, a throughput that is less than the threshold may indicate that the UE is capable of sufficiently handling the throughput via the 4G LTE RAT without assistance from the 5G NR RAT. In such a situation, the 5G NR RAT may be disabled (e.g., one or more portions of the 5G modem and/or RF components may be powered down, or the 5G modem and/or RF components are completely shut off or completely powered down) to thereby reduce power consumption of the UE. Information related to 5G NR (e.g., control information) may be communicated to and/or from the UE via the 4G LTE RAT, which may provide a master node. The threshold may be based on a combined UL and DL throughput capacity of a RAT. In one example, the threshold may be 20 mega-bits-per-second (Mbps). In another example, the threshold may be 1 Mbps. In another example, the threshold may be determined based on the throughput capacity of multiple ones of the RATs of the UE.

The UE may be in the relaxed doze mode between T1 and T3 as shown in FIG. 4 with one or more of its RATs disabled (e.g., one or more components are powered down, a RAT is deactivated, measurement reports are muted, multi-connectivity reconfiguration requests are denied). Disabling of a RAT may lead to power savings as reflected in the relatively low power consumption depicted between T1 and T3. When a RAT is disabled one or more measurement reports associated with the disabled RAT may be muted (e.g., sent with null results using another enabled RAT) or not sent. For example, when the disabled RAT corresponds to 5G NR and an enabled RAT corresponds to 4G LTE, LTE-to-NR (L2N) measurement reports may be muted or not sent. In one example, an event-based measurement reports corresponding to 5G NR may be muted (e.g., not sent) on the 4G LTE RAT. In another example, a periodic measurement report corresponding to 5G NR may be sent with null results on the 4G LTE RAT. The UE may receive a multi-connectivity secondary node configuration or reconfiguration (e.g., addition) message (e.g., an EN-DC addition (e.g., “blind” addition) message, an SCG addition message) when a RAT is disabled, and the UE may respond by sending a configuration or reconfiguration failure message (e.g., fail EN-DC addition message) indicating that the UE cannot accept the reconfiguration message. The UE may report an SCGFailureInformationNR message with failureType=synchReconfigFailure-SCG and not include a measResultFreqListNR message in response to receiving a reconfiguration message when a RAT is disabled. The secondary node configuration or reconfiguration message and the response by the UE may be communicated in one or more RRC connection reconfiguration messages. Measurement muting and failure reporting may be utilized in CA scenarios (e.g., non-colocated CA cases, inter-band CA cases, etc.).

Between T1 and T2 the UE detects that it is moving. At T2, the UE detects that it is stationary and enters the pre-doze mode (e.g., the UE's screen is off and it is stationary and unplugged) and the pre-doze timer begins. At time T3, the UE determines that the throughput estimation is above the threshold, and the UE exits the relaxed doze mode and the RAT that was disabled during the relaxed doze mode is enabled (or re-enabled). Enabling of the disabled RAT is represented by an increase in the power consumption between T3 and T4 compared to the power consumption during the relaxed doze mode. At T3 the other conditions for the pre-doze mode remain satisfied so the UE remains in the pre-doze mode and continues to run the pre-doze timer. The UE may exit the relaxed doze mode and re-enable the disabled RAT for other reasons such as the screen being turned on or the UE being plugged into a power source, which may also cause the UE to exit the pre-doze mode. When the UE enables or re-enables the RAT the UE may unmute or resume measurement reports (e.g., L2N measurement reports).

At T4 the pre-doze timer expires and the UE enters the doze mode. In the doze mode of FIG. 4 one or more of the RATs of the UE may be disabled similar to the disabling of a RAT in the relaxed doze mode. Disabling one or more of the RATs (e.g., a 5G NR RAT) during the doze mode may provide additional power savings compared to conventional systems or methods (e.g., such as the doze mode described in FIG. 3). During the doze mode of FIG. 4 the UE may have maintenance windows (e.g., between T5 and T6) to communicate information, but the disabled RAT remains disabled during the maintenance window. An enabled RAT (e.g., 4G LTE) or WiFi may be used during the maintenance window to communicate the information. In one aspect, during the doze mode of FIG. 4, the UE may estimate a throughput to determine whether one or more of the RATs should be disabled. If the estimated throughput of the UE is at or above a threshold, the UE may enable a disabled RAT but remain in the doze mode if other conditions of the doze mode are satisfied (e.g., screen off, stationary and unplugged after the pre-doze timer expires). In another aspect, during the doze mode of FIG. 4, a disabled RAT may remain disabled while the UE is in the doze mode regardless of an estimated throughput meeting or exceeding a threshold.

At T7 the UE exits the doze mode. The UE may exit the doze mode based on one or more factors such as the UE's screen being turned on, the UE being plugged into a power source, and/or the UE being mobile. The disabled RAT may be enabled in response to the UE exiting the doze mode at T7, and, thus, power usage of the UE may increase.

At T8 the UE enters a mode or state, which may be referred to as an active WiFi connection mode or state. In the active WiFi connection mode the UE is connected to a WiFi network. In the active WiFi connection mode the UE may automatically route some or all its data traffic through WiFi and may disable one or more RATs (e.g., 5G NR RAT), which may lower the UE's power consumption.

One or more RATs may be disabled in response to the UE being in other modes or states. For example, the UE may determine that it is in a mode or state, which may be referred to as a low battery mode or state, in which the remaining battery power is below a threshold (e.g., 20% battery remaining). In the low battery mode, the UE may determine to disable a RAT, such as a 5G NR RAT, to save battery power. In disabling the RAT, measurement reports described above may be muted or sent with null results and/or multi-connectivity reconfiguration failure messages may be sent from the UE to a network. In another example, the UE may determine to disable a RAT based on other factors such as an application type or a thermal condition or situation associated with the UE. In another example, the second RAT may be disabled by default when a new RRC connection is established with respect to the first RAT, which may be referred to as a new connection mode or state. In another example, the UE may disable a RAT when the UE's screen is off and a throughput estimate is low regardless of whether the UE is plugged into a power source.

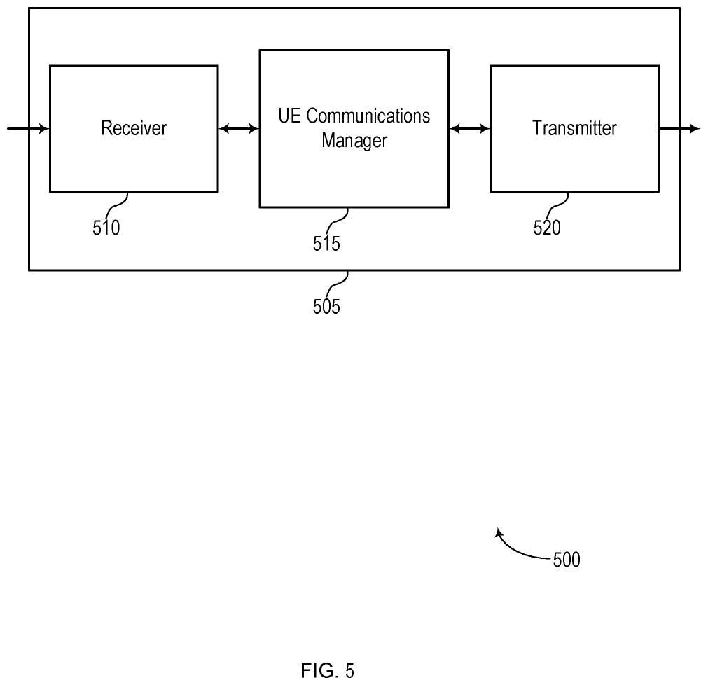

FIG. 5 shows a block diagram 500 of a wireless device 505 that supports power savings in a multi-connectivity UE in accordance with aspects of the present disclosure. Wireless device 505 may be an example of aspects of a user equipment (UE) 115 as described herein. Wireless device 505 may include receiver 510, UE communications manager 515, and transmitter 520. Wireless device 505 may also include a processor. Each of these components may be in communication with, or coupled to, one another (e.g., via one or more buses). Wireless device 505 may provide means for communicating with multiple RATs, means for determining a state or mode of the UE, means for disabling a RAT, means for enabling or re-enabling a RAT, and various other means for performing the functions described herein.

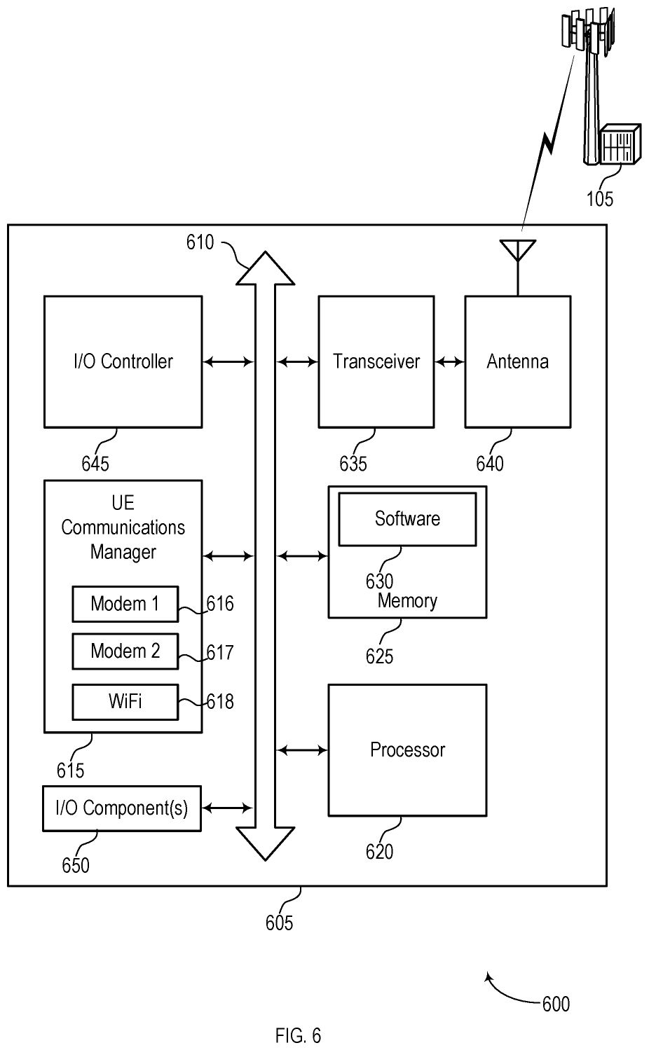

Receiver 510 may receive information such as packets, user data, or control information associated with various information channels (e.g., control channels, data channels, etc.). Information may be passed on to other components of the device. The receiver 510 may utilize a single antenna or a set of antennas. The receiver 510 may be an example of aspects of the transceiver 635 described with reference to FIG. 6.

UE communications manager 515 and/or at least some of its various sub-components may be implemented in hardware, software executed by a processor, firmware, or any combination thereof. If implemented in software executed by a processor, the functions of the UE communications manager 515 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The UE communications manager 515 and/or at least some of its various sub-components may be physically located at various positions, including being distributed such that portions of functions are implemented at different physical locations by one or more physical devices. In some examples, UE communications manager 515 and/or at least some of its various sub-components may be a separate and distinct component in accordance with various aspects of the present disclosure. In other examples, UE communications manager 515 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure. UE communications manager 515 may be an example of aspects of the UE communications manager 615 described with reference to FIG. 6.

UE communications manager 515 may determine an operating mode or state (e.g., relaxed doze mode, pre-doze mode, doze mode, active WiFi communication mode, active mode) of device 505 and may determine whether to disable, enable or re-enable a RAT based on the operating mode, as described with reference to FIGS. 1-4.

Transmitter 520 may transmit signals generated by other components of the device. In some examples, the transmitter 520 may be collocated with receiver 510 in a transceiver module. For example, the transmitter 520 may be an example of aspects of the transceiver 635 described with reference to FIG. 6. The transmitter 520 may utilize a single antenna or a set of antennas.

FIG. 6 shows a diagram of a system 600 including a device 605 that supports power savings in a multi-connectivity UE in accordance with aspects of the present disclosure. Device 605 may be an example of or include the components of wireless device 505, or a UE 115 as described above, e.g., with reference to FIGS. 1 through 5. Device 605 may include components for bi-directional voice and data communications including components for transmitting and receiving communications, including UE communications manager 615, processor 620, memory 625, software 630, transceiver 635, antenna 640, I/O controller 645, and I/O component(s) 650. These components may be in communication (e.g., electronic communication), or coupled, via one or more buses (e.g., bus 610). Device may include various other components not depicted in FIG. 6 such as a battery. Device 605 may communicate wirelessly with one or more base stations 105. Wireless device 605 may provide means for communicating with multiple RATs, means for determining a state or mode of the UE, means for disabling a RAT, means for enabling or re-enabling a RAT, and various other means for performing the functions described herein.

UE communications manager 615 may be an example of UE communications manager 515 of FIG. 5. UE communications manager 615 may include a modem manager 616 associated with a first RAT (e.g., 4G LTE), a modem manager 617 associated with a second RAT (e.g., 5G NR) and a WiFi manager 618 associated with WiFi communications. UE communications manager 615 may enable device 605 to determine an operating state of device 605 and to determine whether to disable, enable or re-enable one or more RATs (e.g., disable, enable or re-enable one or more modems) of device 605.

Processor 620 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 620 may be configured to operate a memory array using a memory controller. In other cases, a memory controller may be integrated into processor 620. Processor 620 may be configured to execute computer-readable instructions stored in a memory to perform various functions (e.g., functions or tasks supporting power savings in a multi-connectivity UE). Information such as OS information, application statistics, application throughputs, batter voltage status may be inter-communicated between various parts of device 605 via bus 610 and the inter-communication may incorporate an interface such as a modem to application processor interface.

Memory 625 may include random access memory (RAM) and read only memory (ROM). The memory 625 may store computer-readable, computer-executable software 630 including instructions that, when executed, cause a processor (e.g., processor 620, UE communications manager 615) to perform various functions described herein. In some cases, the memory 625 may contain, among other things, a basic input/output system (BIOS) which may control basic hardware or software operation such as the interaction with peripheral components or devices.

Software 630 may include code to implement aspects of the present disclosure, including code to support power savings in a multi-connectivity UE. Software 630 may be stored in a non-transitory computer-readable medium such as system memory or other memory. In some cases, the software 630 may not be directly executable by a processor but may cause a computer (e.g., when compiled and executed) to perform functions described herein.

Transceiver 635 may communicate bi-directionally, via one or more antennas, wired, or wireless links as described above. For example, the transceiver 635 may represent a wireless transceiver and may communicate bi-directionally with another wireless transceiver. The transceiver 635 may also include a modem to modulate the packets and provide the modulated packets to the antennas for transmission, and to demodulate packets from signals received from the antennas. In one example, transceiver 635 may include multiple modems (separate or integrated) associated with multiple RATs. For example, transceiver 635 may include at least a 5G NR modem and a 4G LTE modem.

In some cases, the wireless device may include a single antenna 640. However, in some cases the device may have more than one antenna 640, which may be capable of concurrently transmitting or receiving multiple wireless transmissions.

I/O controller 645 may manage input and output signals for device 605. I/O controller 645 may also manage peripherals not integrated into device 605. In some cases, I/O controller 645 may represent a physical connection or port to an external peripheral. In some cases, I/O controller 645 may utilize an operating system such as iOS®, ANDROID®, MS-DOS®, MS-WINDOWS®, OS/2®, UNIX®, LINUX®, or another known operating system. In other cases, I/O controller 645 may represent or interact with a modem, a keyboard, a mouse, a touchscreen, or a similar device. In some cases, I/O controller 645 may be implemented as part of a processor. In some cases, a user may interact with device 605 via I/O controller 645 or via hardware components controlled by I/O controller 645.

I/O component(s) 650 may include various components and/or parts that enable interaction with device 605. For example, I/O components(s) may include a screen, touchscreen, speaker, microphone, keyboard or other I/O device.

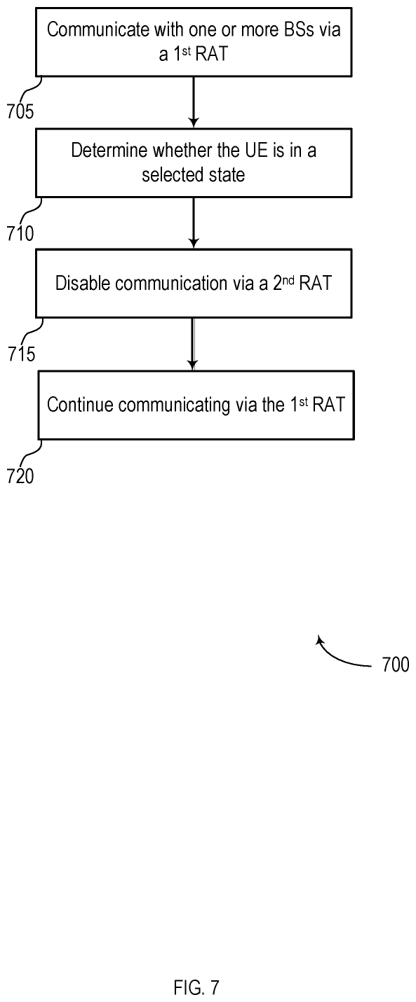

FIG. 7 shows a flowchart illustrating a method 700 for power savings in a multi-connectivity UE in accordance with aspects of the present disclosure. The operations of method 700 may be implemented by a UE 115 or its components as described herein. For example, the operations of method 700 may be performed by a UE communications manager, processor, receiver, transmitter and/or transceiver as described with reference to FIGS. 5 and 6. In some examples, a UE 115 may execute a set of codes to control the functional elements of the device to perform the functions described below. Additionally, or alternatively, the UE 115 may perform aspects of the functions described below using special-purpose hardware. Moreover, wireless device 505 and/or wireless device 605 may execute one or more of the operations of FIG. 7 to provide means for communicating with multiple RATs, means for determining a state or mode of the UE, means for disabling a RAT, means for enabling or re-enabling a RAT, and various other means for performing the functions described herein.

At block 705 the UE 115 may communicate with one or more base stations 105 via a first RAT and a second RAT. Although not required, the UE 115 may also communicate with the one or more base stations 105 via a second RAT. The second RAT may have a higher throughput capability and a higher power consumption at the UE 115 than the first RAT. In one example, the first RAT may correspond to a 4G LTE RAT and the second RAT may correspond to a 5G NR RAT. The 4G LTE RAT and the 5G NR RAT may be operating in a DC mode. In another example, the first RAT and the second RAT may be the same. The operations of block 705 may be performed according to the methods described herein. In certain examples, aspects of the operations of block 705 may be performed by a receiver, transmitter, and/or transceiver as described with reference to FIGS. 5 and 6.

At block 710 the UE 115 may determine whether the UE 115 is in a selected state. The selected state may correspond to an active mode, a relaxed doze mode, a pre-doze mode, a doze mode, an active WiFi connection mode, a low battery mode, other modes or states described therein, or a combination thereof described above with reference to FIGS. 3 through 6. In one example, the selected state corresponds to the relaxed doze mode. In another example, the selected state corresponds to the relaxed doze mode or the doze mode or the active WiFi connection mode wherein if the UE 115 is in any one of those modes, the UE is in the selected state. The UE 115 may periodically determine whether the UE is in the selected state. In one example, the UE 115 may estimate a throughput and compare the throughput to a threshold to determine whether the UE is in the selected state. The UE 115 may also determine whether other conditions are satisfied (e.g., a screen off condition, an unplugged condition) to determine whether the UE 115 is in the selected state. The operations of block 710 may be performed according to the methods described herein. In certain examples, aspects of the operations of block 710 may be performed by a UE communications manager as described with reference to FIGS. 5 and 6.

At block 715 the UE 115 may disable the second RAT in response to determining that the UE 115 is in the selected state. In one example, the UE 115 may disable the second RAT by powering down one or more of the components (e.g., modem, RF components) of the second RAT. In one example, the second RAT may be disabled during a start-up of the UE, and the second RAT may remain disabled if the UE is in the selected state after start-up. The operations of block 715 may be performed according to the methods described herein. In certain examples, aspects of the operations of block 715 may be performed by a UE communications manager, processor, receiver, transmitter and/or transceiver as described with reference to FIGS. 5 and 6.

At block 720 the UE 115 may continue to communicate via the first RAT. The communications may include information related to the first RAT and/or the second RAT. The operations of block 720 may be performed according to the methods described herein. In certain examples, aspects of the operations of block 720 may be performed by a receiver, transmitter, and/or transceiver as described with reference to FIGS. 5 and 6.

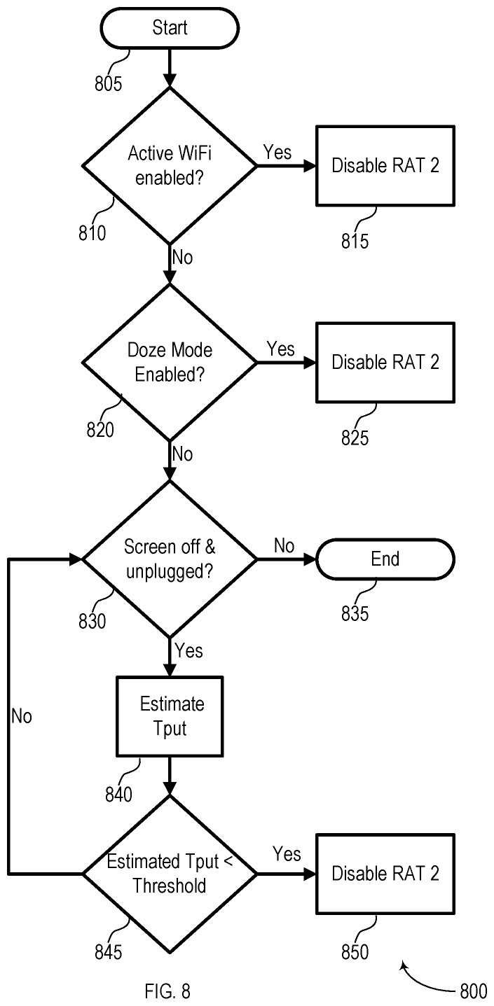

FIG. 8 shows a flowchart illustrating a method 800 for power savings in a multi-connectivity UE in accordance with aspects of the present disclosure. The multi-connectivity UE may be configured to communicate via a first RAT and a second RAT. In one example, the first RAT may be an 4G LTE RAT and the second RAT may be a 5G NR RAT. The operations of method 800 may be implemented by a UE 115 or its components as described herein. For example, the operations of method 800 may be performed by a UE communications manager, processor, receiver, transmitter and/or transceiver as described with reference to FIGS. 5 and 6. In some examples, a UE 115 may execute a set of codes to control the functional elements of the device to perform the functions described below. Additionally, or alternatively, the UE 115 may perform aspects of the functions described below using special-purpose hardware. The operations of method 800 may be repeated periodically (e.g., every 30 seconds) or aperiodically. Moreover, wireless device 505 and/or wireless device 605 may execute one or more of the operations of FIG. 8 to provide means for communicating with multiple RATs, means for determining a state or mode of the UE, means for disabling a RAT, means for enabling or re-enabling a RAT, and various other means for performing the functions described herein.

At block 810 the UE 115 may determine whether the UE is in the active WiFi connection mode (e.g., whether the active WiFi connection mode is enabled). The operations of block 810 may be performed according to the methods described herein. In certain examples, aspects of the operations of block 810 may be performed by a UE communications manager as described with reference to FIGS. 5 and 6.

If it is determined that the UE is in the active WiFi mode in block 810 the method proceeds to block 815 in which the second RAT (e.g., 5G NR) is disabled. If the UE determines that it is no longer in the active WiFi mode while in block 815, the UE may enable or re-enable the second RAT and return to a start block 805. The operations of block 815 may be performed according to the methods described herein. In certain examples, aspects of the operations of block 815 may be performed by a UE communications manager, processor, receiver, transmitter and/or transceiver as described with reference to FIGS. 5 and 6.

If it is determined that the UE is not in the active WiFi mode in block 810 the method proceeds to block 820 in which the UE may determine whether the UE is in the doze mode. The operations of block 820 may be performed according to the methods described herein. In certain examples, aspects of the operations of block 820 may be performed by a UE communications manager as described with reference to FIGS. 5 and 6.

If it is determined that the UE is in the doze mode in block 820 the method proceeds to block 825 in which the second RAT (e.g., 5G NR) is disabled. If the UE determines that it is no longer in the doze mode while in block 825, the UE may enable or re-enable the second RAT and return to the start block 805. The operations of block 825 may be performed according to the methods described herein. In certain examples, aspects of the operations of block 825 may be performed by a UE communications manager, processor, receiver, transmitter and/or transceiver as described with reference to FIGS. 5 and 6.

If it is determined that the UE is not in the doze mode in block 820 the method proceeds to block 830 in which the UE may determine whether the UE is unplugged and a screen of the UE is off. The operations of block 830 may be performed according to the methods described herein. In certain examples, aspects of the operations of block 830 may be performed by a UE communications manager as described with reference to FIGS. 5 and 6.

If it is determined that the UE's screen is not off or the UE is not unplugged in block 830 the method proceeds to block 835 in which the method ends. The UE may then return to the start block 805 and repeat the method. The UE may repeat the method periodically or aperiodically. The operations of block 835 may be performed according to the methods described herein. In certain examples, aspects of the operations of block 835 may be performed by a UE communications manager as described with reference to FIGS. 5 and 6.

If it is determined that the UE's screen is off and the UE is unplugged in block 830 the method proceeds to block 840 in which the UE estimates a throughput. The operations of block 840 may be performed according to the methods described herein. In certain examples, aspects of the operations of block 840 may be performed by a UE communications manager as described with reference to FIGS. 5 and 6.

The method proceeds from block 840 to block 845. At block 845 the UE 115 may compare the estimated throughput to a threshold. The operations of block 845 may be performed according to the methods described herein. In certain examples, aspects of the operations of block 845 may be performed by a UE communications manager as described with reference to FIGS. 5 and 6.

If it is determined that the estimated throughput is less than the threshold at block 845 the method proceeds to block 850 in which the second RAT (e.g., 5G NR) is disabled. If the UE determines that the estimated throughput is less than the threshold at block 845 the UE may also determine that the UE is in the relaxed doze mode. If the UE determines that it is no longer in the relaxed doze mode while in block 850, the UE may enable or re-enable the second RAT and return to the start block 805. The operations of block 850 may be performed according to the methods described herein. In certain examples, aspects of the operations of block 850 may be performed by a UE communications manager, processor, receiver, transmitter and/or transceiver as described with reference to FIGS. 5 and 6.

If it is determined that the estimated throughput is greater than or equal to the threshold at block 845 the method may return to block 830 and repeat the method from block 830. The method may be repeated from block 830 periodically or aperiodically.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE and LTE-A are releases of UMTS that use E-UTRA. UTRA, E-UTRA, UMTS, LTE, LTE-A, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects of an LTE or an NR system may be described for purposes of example, and LTE or NR terminology may be used in much of the description, the techniques described herein are applicable beyond LTE or NR applications.

A macro cell generally covers a relatively large geographic area (e.g., several kilometers in radius) and may allow unrestricted access by UEs 115 with service subscriptions with the network provider. A small cell may be associated with a lower-powered base station 105, as compared with a macro cell, and a small cell may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs 115 with service subscriptions with the network provider. A femto cell may also cover a small geographic area (e.g., a home) and may provide restricted access by UEs 115 having an association with the femto cell (e.g., UEs 115 in a closed subscriber group (CSG), UEs 115 for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells, and may also support communications using one or multiple component carriers.

The wireless communications system 100 or systems described herein may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication in a multi-connectivity user equipment (UE), comprising:
communicating with one or more base stations via a first radio access technology (RAT);
determining whether the UE is in a selected state, wherein the selected state comprises a state in which:
a screen of the UE is off;
the UE is unplugged from a power source; and
a throughput estimation of the UE is less than a threshold;
disabling communication via a second RAT in response to determining that the UE is in the selected state;
continuing to communicate via the first RAT; and
muting a measurement report associated with the second RAT.

2. The method of claim 1, wherein the selected state is independent of a mobility condition.

3. The method of claim 1, wherein entry into the selected state is independent of a time duration in which:
the screen of the UE is off; and
the UE is unplugged from the power source.

4. The method of claim 1, wherein the throughput estimation is determined based on cross-layer information.

5. The method of claim 4, wherein the throughput estimation corresponds to a medium access control (MAC) layer throughput estimation.

6. The method of claim 5, wherein the throughput estimation is determined based on a throughput prediction over a time window.

7. The method of claim 4, wherein the throughput estimation corresponds to application usage statistics.

8. The method of claim 1, further comprising periodically determining the throughput estimation of the UE while the UE is in the selected state.

9. The method of claim 1, wherein the throughput estimation is an average throughput estimation.

10. The method of claim 1, wherein the selected state comprises a state in which the UE is stationary.

11. The method of claim 10, wherein the selected state comprises a state in which:
the screen of the UE is off for a period of time;
the UE is unplugged from the power source for the period of time; and
the UE is stationary for the period of time.

12. The method of claim 1, wherein the selected state comprises an active WiFi connection mode.

13. The method of claim 1, wherein the selected state comprises a low battery state in which a remaining battery power of the UE is below a threshold.

14. The method of claim 1, wherein control information related to the second RAT is communicated via the first RAT.

15. The method of claim 1, wherein the first RAT corresponds to fourth generation (4G) wireless wide area connectivity (WWAN) technology and the second RAT correspond to fifth generation (5G) WWAN technology.

16. The method of claim 1, wherein determining whether the UE is in the selected state comprises communicating operating system information, application level information, or a combination thereof between an application processor and a modem of the UE.

17. The method of claim 1, wherein disabling the second RAT comprises powering down one or more components related to the second RAT.

18. The method of claim 17, wherein the one or more components comprise a modem and radio frequency (RF) components of the second RAT.

19. The method of claim 1, wherein the measurement report comprises one or both of an event-based measurement report for the second RAT and a periodic measurement report for the second RAT.

20. The method of claim 1, further comprising:
determining that the UE is not in the selected state;
enabling or re-enabling communication via the second RAT; and
unmuting the measurement report associated with the second RAT.

21. The method of claim 1, further comprising:
receiving a multi-connectivity secondary node reconfiguration message; and
sending a secondary node reconfiguration failure message.

22. A multi-connectivity user equipment (UE) for wireless communication, comprising:
a screen;
one or more processors;
memory coupled to the one or more processors; and
instructions stored in the memory and operable, when executed by the one or more processors, to cause the UE to:
communicate with one or more base stations via a first radio access technology (RAT);
determine whether the UE is in a selected state, wherein the selected state comprises a state in which:
the screen of the UE is off;
the UE is unplugged from a power source; and
a throughput estimation of the UE is less than a threshold;
disable communication via a second RAT in response to a determination that the UE is in the selected state;
continue to communicate via the first RAT; and
mute a measurement report associated with the second RAT.

23. The UE of claim 22, wherein the selected state is independent of a mobility condition of the UE.

24. A multi-connectivity user equipment (UE) for wireless communication, comprising:
means for communicating with one or more base stations via a first radio access technology (RAT);
means for determining whether the UE is in a selected state, wherein the selected state comprises a state in which:
a screen of the UE is off;
the UE is unplugged from a power source; and
a throughput estimation of the UE is less than a threshold;
means for disabling communication via a second RAT in response to determining that the UE is in the selected state;
means for continuing to communicate via the first RAT; and
means for muting a measurement report associated with the second RAT.

25. A non-transitory computer readable medium storing code for wireless communication in a multi-connectivity user equipment (UE), the code comprising instructions executable by a processor to:
communicate with one or more base stations via a first radio access technology (RAT);
determine whether the UE is in a selected state, wherein the selected state comprises a state in which:
a screen of the UE is off;
the UE is unplugged from a power source; and
a throughput estimation of the UE is less than a threshold;
disable communication via a second RAT in response to a determination that the UE is in the selected state;
continue to communicate via the first RAT; and
mute a measurement report associated with the second RAT.
